(19) United States
(12) Patent Application Publication
(10) Pub. No.: US 2012/0326893 A1
(43) Pub. Date: Dec. 27, 2012

(54) METHOD AND SYSTEM FOR COORDINATING PERMITTED USE OF A PARKING SPACE

(76) Inventor: Abraham Glezerman, Tel-Aviv (IL)

(21) Appl. No.: 13/167,129

(22) Filed: Jun. 23, 2011

(51) Int. Cl. B60Q 1/48

(52) U.S. Cl. 340/932.2

(57) ABSTRACT

Managing shared usage of a set of parking spaces. A system includes a processor, a control circuit, a memory, and a communication interface. One or more software modules are encoded in the memory that execute a parking management application in the processor. When executed the parking management application configures the control circuit to: receive a user input from an owner through the communication interface, concerning a parking space, an availability of the parking space and a user location. The parking management application further configures the control circuit to receive a request from a visitor through the communication interface to park among the set of parking spaces, process the request together with the user input and user location to determine an optimal parking arrangement, assign a parking destination to the visitor based on the optimal parking arrangement; and transmit the assigned parking destination to the visitor.

### TECHNICAL FIELD OF THE INVENTION

This disclosure relates generally to the field of parking space management, and, in particular, to systems and methods for optimizing the management and allocation of parking spaces.

### BACKGROUND OF THE INVENTION

In many urban areas, drivers regularly face considerable challenges when attempting to park their cars. Due to population density, traffic volume, and the high cost of real estate, drivers in large cities frequently experience difficulty locating a suitable parking space for their cars, especially during peak travel times. As a result, city drivers generally must choose to spend additional time and resources driving around while searching for a parking space, pay substantial parking fees to a parking lot (assuming that the lot has a space available, which may or may not be the case), or park in an illegal space and risk being issued a parking ticket and/or having the car towed.

An additional cause of the parking challenges faced by urban drivers is the non-optimal allocation and use of existing parking resources. That is, while many parking spaces do exist in urban areas (such as lots connected to and/or within commercial and residential high-rise buildings), a significant portion of these spaces are owned and/or leased by individuals or corporate entities. As a result, any number of these owned/leased parking spaces can be vacant at a given time, however, due to ownership constraints, these spaces go unutilized during the time they are vacant. One solution proposed is described at a website parkspool.com, but this solution does not analyze of usage patterns of spot owners or visitors, does not monitor the position of the users of the system and, as such, does not provide a system that is adapted for making optimized selections of, or dynamic adjustments to, parking spot assignments in view of correlated usage information, nor does that system or any other known system seek to optimize efficient use of limited parking resources.

It is with respect to these and other considerations that the disclosure made herein is presented.

### SUMMARY OF THE INVENTION

Technologies are presented herein for a system and method for managing shared usage of a set of parking spaces. According to one aspect, a system is provided, including a processor, a control circuit operatively connected to the processor, a memory operatively connected to the control circuit and accessible by the processor, and a communication interface operatively connected to the control circuit. One or more software modules are encoded in the memory that execute a parking management application in the processor. When executed by the processor, the parking management application configures the control circuit to: receive a user input from an owner through the communication interface, the user input corresponding to a parking space and comprising identification information and availability information relating to the parking space, receive a user location from the owner through the communication interface, the user location comprising one or more geographical coordinates. The parking management application further configures the control circuit to receive a request from a visitor through the communication interface to park among the set of parking spaces, process the request together with the user input and user location to determine an optimal parking arrangement, assign a parking destination to the visitor based on the optimal parking arrangement; and transmit the assigned parking destination to the visitor.

These and other aspects, features, and advantages can be appreciated from the accompanying description of certain embodiments of the invention and the accompanying drawing figures.

### BRIEF DESCRIPTION OF THE DRAWINGS

FIG. 1 is a high-level diagram illustrating an exemplary configuration of a parking management system; and

FIG. 2 a flow diagram is described showing a routine 200 that illustrates a broad aspect of a method for managing shared usage of a set of parking spaces in accordance with one exemplary embodiment.

### DETAILED DESCRIPTION OF CERTAIN EMBODIMENTS OF THE INVENTION

The following detailed description is directed to systems and methods for parking space management. References are made to the accompanying drawings that form a part hereof, and which are shown by way of illustration through specific embodiments, arrangements, and examples.

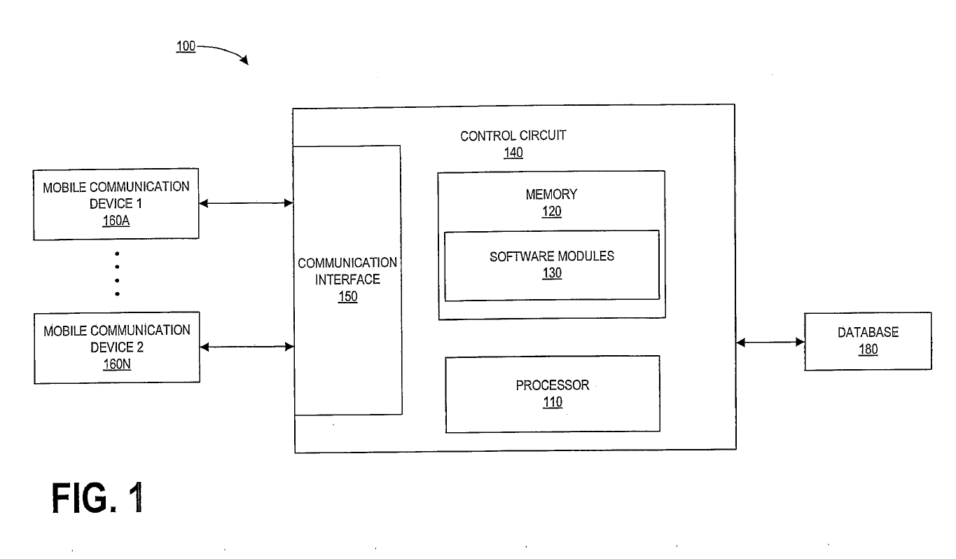

Referring now to the drawings, it is to be understood that like numerals represent like elements through the several figures, and that not all components and/or steps described and illustrated with reference to the figures are required for all embodiments or arrangements. FIG. 1 is a high-level diagram illustrating an exemplary configuration of a parking management system 100. In one arrangement, parking management system 100 can be a computer such as a personal computer or a server. In another arrangement, parking management system 100 can be a plurality of computers in communication with one another, though it should be understood that parking management system 100 can be practically any computing device capable of embodying the systems and/or methods described herein.

Parking management system 100 includes a control circuit 140 which is operatively connected to various hardware and software components that serve to enable operation of the parking management system. The control circuit 140 is operatively connected to a processor 110 and a memory 120. Preferably, memory 120 is accessible by processor 110, thereby enabling processor 110 to receive and execute instructions stored on memory 120.

One or more software modules 130 are encoded in memory 120. The software modules 130 can comprise a software program or set of instructions executed in processor 110. Preferably, the software modules 130 make up a parking management application that is executed by processor 110. During execution of the software modules 130, the processor 110 configures the control circuit 140 to manage and optimize the shared usage of a set of parking spaces, as will be described in greater detail below. It should be noted that while FIG. 1 depicts memory 120 oriented on control circuit 140, in an alternate arrangement, memory 120 can be practically any storage medium (such as a hard disk drive, flash memory, etc.) that is operatively connected to the control circuit 140, even if not oriented on control circuit 140 as depicted in FIG. 1.

Also connected to control circuit 140 is a database 180. Database 180 receives, transmits, and stores data and/or information received by and/or pertaining to the operation of the parking management system 100, as will be described in greater detail below. Database 180 is preferably a computing device (such as a personal computer or server) and/or several connected computing devices with a storage medium that is capable of maintaining the data/information generated and/or received by parking management system 100. In an alternate arrangement, database 180 can be a data storage device such as a hard disk, or an array of storage devices (e.g., RAID). It should be noted that while FIG. 1 depicts database 180 as a being a stand-alone element that is communicatively connected to control circuit 140, in other arrangements database 180 can be oriented on control circuit 140, such as being incorporated into memory 120.

A communication interface 150 is also operatively connected to control circuit 140. Communication interface 150 can be any interface that enables communication between the control circuit 140 and external devices, machines and/or elements. Preferably, communication interface 150 is a network interface controller such as an Ethernet or wireless (802.11) network adapter, thought it should be understood that communication interface 150 can be practically any interface that enables communication to/from the control circuit 140.

At various points during the operation of parking management system 100, control circuit 140 can communicate with one or more mobile communication devices 160a-n (collectively mobile communication devices 160). For ease of reference, mobile communication device 160a will be used to refer to the mobile device associated with the owner of a given parking space, while mobile communication device 160n will be used to refer to the mobile device associated with a potential visitor who is seeking a parking space. The mobile communication devices 160 transmit and/or receive data to/from the control circuit 140, as will be described in greater detail below. While mobile communication device 160 can be practically any device capable of communication with control circuit 140, in the preferred embodiment communication device 160 is a cellular phone, smartphone, and/or portable device that is capable of transmitting and receiving data to/from the control circuit 140 as well as determining geographic location coordinates (such as through an integrated GPS or triangulation techniques, as are known to those of skill in the art). The user of mobile communication device 160 (either the owner of a parking space or a potential visitor) preferably interacts with parking management system 100 through an application or ‘app’ executing on the user's mobile communication device 160. This application or ‘app’ provides a simple and intuitive user interface that enables the user (whether in the role of an owner or a visitor) to receive, review, and input data, information, and/or settings that relate to the operation of the parking management system 100, as will be described in greater detail below. In an alternate arrangement, the owner and/or visitor can communicate with parking management system 100 through a website and/or a web-based interface. In such an arrangement, the user need not execute the referenced application on his/her mobile communication device 160, rather the referenced website enables substantially the same functionality through a web-interface.

It should be noted that while the present disclosure describes mobile communication device 160a with reference to an owner of a parking space, and mobile communication device 160n with reference to a visitor, these labels are only for ease of reference and clarity. Ultimately, each of the mobile communication devices 160 can take on the role of either owner or visitor under the proper circumstances, in the manner described herein. Additionally, while the present disclosure primarily describes the parking management system 100 with respect to mobile communication device 160a and mobile communication device 160n, it should be understood that any number of mobile communication devices can interact with parking management system 100 in the manner described herein.

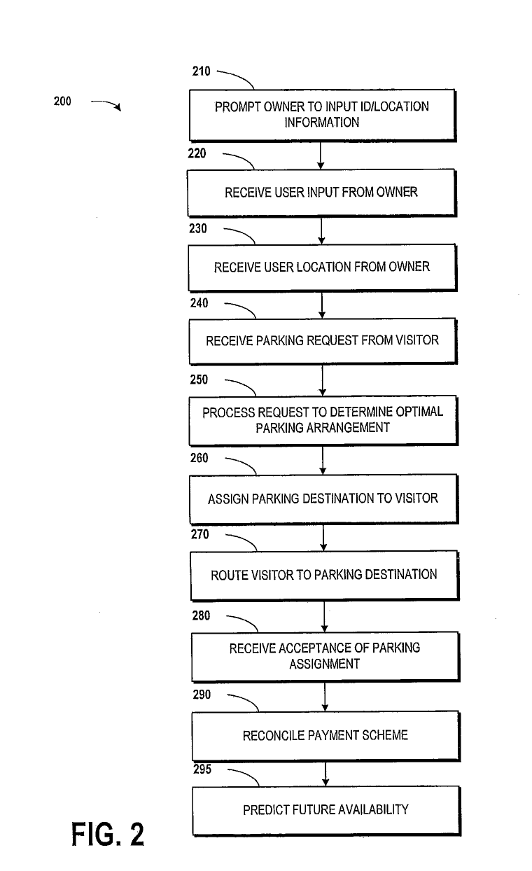

The operation of the parking management system 100 and the various elements described above will be further appreciated with reference to the method for managing shared usage of a set of parking spaces as described below, in conjunction with FIG. 2.

Turning now to FIG. 2, a flow diagram is described showing a routine 200 that illustrates a broad aspect of a method for managing shared usage of a set of parking spaces in accordance with at least one embodiment disclosed herein. It should be appreciated that several of the logical operations described herein are implemented (1) as a sequence of computer implemented acts or program modules running on parking management system 100 (and/or mobile communication device 160) and/or (2) as interconnected machine logic circuits or circuit modules within the parking management system 100 (and/or mobile communication device 160). The implementation is a matter of choice dependent on the requirements of the device (e.g., size, energy, consumption, performance, etc.). Accordingly, the logical operations described herein are referred to variously as operations, structural devices, acts, or modules. Various of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

The process begins at step 210, where the owner of a specific parking space is prompted, preferably through an application executing on the owner's mobile communication device 160a, to provide a user input that is to be transmitted to the parking management system 100. The owner's user input preferably includes identification information including location information that identifies the exact location of the parking space that is under the ownership and/or control of the owner, as well as additional information (such as a space number) that can further identify the owner's parking space from among a set of parking spaces. It should be noted that the application can be configured to save and/or retain this information, such as through the creation of a user account, such that the referenced identification information can be retrieved and/or populated automatically, without the need for repeated manual input by the owner. Additionally, it should be noted that in certain embodiments the user can provide a user input that is not in response to a specific prompt. For example, the user can initiate the input of the identification information, location information, etc., referenced above (such as through an app or application executing at mobile communication device 160a). In yet another arrangement, the owner can be prompted, as described above, in response to a particular occurrence or event. By way of example, the owner of a specific parking space can be prompted, as described above, in response to the detection of a change in the owner's location (such as through a GPS or other such location determining means that are integrated into or otherwise accessible by mobile communication device 160a). By way of further example, information from other sources such as the owner's calendar (which can include, for example, travel plans, events, etc.) can be analyzed by an application executing on the owner's mobile communication device 160a in order to identify scheduling information that can suggest and/or indicate that the owner may not (or will not) be utilizing the owner's parking space at specific times. In such a scenario, the application can prompt the user by inquiring as to whether the owner's parking space will be vacant at the referenced time(s).

The owner's user input also preferably includes availability information which relates to the availability status of the owner's parking space. In one arrangement, the user is prompted through the application executing on the user's mobile communication device 160a to input one or more times or ranges of time during which the owner's parking space will be vacant. By way of example, the user can input that his/her parking space will be vacant from 2 pm until 5 pm on a specific date. Alternatively, the user can automate the input of availability information, such that the user can schedule periodic and/or recurring availability parameters. For example, using the application executing on the user's mobile communication device 160a, an owner can indicate that his/her parking space will be vacant every Sunday from 10 am to 1 pm, or that his/her parking space will be available the entire first week of September. Furthermore, information from other sources, such as the owner's calendar, can be accessed by and/or imported to the application/app executing at mobile communication device 160a to provide additional availability information, as described in detail above.

Then, at step 220, mobile communication device 160a transmits, and the control circuit 140 (through communication interface 150) receives the user input(s), including the identification information (identifying the owner's specific parking space) and the availability information (defining the times/dates during which the parking space will be available). In one arrangement, the user input is transmitted and/or received through a network/internet connection, such as a cellular or wireless internet connection available at communication device 160. Upon receiving the user input at control circuit 140, the user input can be stored in database 180, thus generating and maintaining a record of the availability of the particular parking space for future reference, as will be described in greater detail below. Additionally, by storing the user input in database 180, the user can input availability information far in advance of the actual time/date of the availability.

At step 230, mobile communication device 160a transmits, and the control circuit 140 (through communication interface 150) receives a user location from the owner. Preferably, the user location comprises one or more geographical coordinates (and/or any other such location-identifying information, such as an address) which correspond to the owner's current location. The user location is preferably obtained from the owner's mobile communication device 160a, such as through an integrated GPS receiver and/or device, as referenced above. The application executing on mobile communication device 160a transmits (preferably via a wireless internet or data connection to which mobile communication device 160a has access, as referenced above) the user location to control circuit 140, either continuously or at periodic intervals. The user location information is received by the control circuit 140, and preferably stored in database 180, in the manner described above. The user location information is utilized to further determine the actual availability of the owner's parking space, as well as to project future availability, as will be described in greater detail below.

It should be noted that in certain arrangements control circuit 140 can continuously receive the user location of communication device 160a throughout the operation of the parking management system 100. In such an arrangement, the parking management system can be configured to automatically adjust the availability status of the owner's parking space if the current user location is within a certain defined radius of the parking space (indicating that the owner is returning to the parking space earlier than originally anticipated).

In this regard, a further aspect of the invention can include an implementation of a reliability factor or index which is updated over time using correlation information as between the time that the owner of the space indicated the space would be available and the actual freeing-up of the space by the owner and the owner's return time to the space, as can be identified from the user location information provided by the communication device. The reliability of the owner can be gauged in this way so that the system can determine a probability that the space, in fact, will become and remain available. This probability can be used by the optimization engine described herein to select a spot for a given visitor that is likely to be available without conflict with the owner for the time required. The reliability factor/index can also be exposed to visitors so that visitors can make parking spot selections and conduct searches for desired parking spots in view of this information.

In like manner, an embodiment of the invention can monitor the arrival and exit times of the visitor and correlate this usage information with the parking spot request to gauge a visitor buffer value. The buffer value is a time-padding or risk factor that a visitor intentionally or empirically includes in the request to ensure that the spot is available. In other words, some visitors may routinely request a spot to be available an hour before and an hour longer than required, yet in practice arrives long after the start of the requested time and leaves well before the end of the requested time. This usage data can reveal a pattern that provides a probability that a parking spot may be a good choice for the optimization engine even if the requested parameters provided by the visitor and the parameters by a given owner do not coincide. This is especially true when the optimization engine takes into account the owner's reliability data as well.

At step 240, the visitor's mobile communication device 160n generates and transmits a request to park among a set of parking spaces. This request is preferably generated through an application executing on the visitor's mobile communication device 160n. The application preferably enables the user to input a desired location, near which (or at which) the visitor wishes to park. It should be noted that the desired location can be a location at which the visitor is not presently located, but where the visitor expects to be located at a future time. Alternatively, the application can utilize the integrated GPS (or any other such location determining method) of the visitor's mobile communication device 160n to determine the current location of the visitor (assuming that the visitor is presently seeking a parking space). The application further enables the user to input the time/time range and date/date range during which the visitor would like to park at the desired location.

Together with the request to park, the visitor can also include additional information and/or preferences that can serve to further optimize the parking arrangement. This information and/or preferences can be input into the application executing on the visitor's mobile communication device 160n, and/or stored as default preferences (thus not needing repeated input), as described in detail above. By way of example, the visitor can indicate that he/she wishes to park only in covered parking lots, or that the visitor drives a large vehicle which requires a larger parking space. By way of further example, the visitor can set a maximum price (such as per hour), above which the visitor does not wish to pay.

Then, at step 250, the parking management application executing at processor 110 processes the visitor's request(s) to determine an optimal parking arrangement. Specifically, the parking management application analyzes one or more user inputs received from various parking space owners. As referenced above, these user inputs are preferably stored in database 180 as a parking space inventory. In one arrangement, the parking management application filters the stored user inputs by location (based on the identification information in the user input) and/or time/date (based on the availability information in the user input), in order to analyze only user inputs that are of immediate relevance to the visitor's request. By way of example, the parking management application can filter the user inputs by location, thus only considering user inputs that are within the desired location specified by the visitor, as referenced above, and/or within a certain radius from the desired location. In addition and/or alternatively, the parking management application can filter the user inputs by time/date, thus only considering user inputs that are within the time/time range and date/date range specified by the visitor, as described above.

Based on the referenced analysis of the received user inputs, the parking management application determines an optimal parking arrangement using an optimization engine (e.g., code such as an optimization module executing on a machine). This determination is achieved by further analyzing the filtered user inputs (those user inputs that are within the desired location specified by the visitor and/or are within the time/date range specified by the visitor) in conjunction with various other parking requests received by parking management system 100 from other potential visitors. In doing so, the parking management application can determine how to most optimally assign parking spaces that are available. This determination can also be achieved, in certain embodiments, but factoring in reliability data associated with the owner's parking spot and actual usage data of the visitor, as described above.

By way of example, consider two available parking spaces: space A and space B, both of which are in the same parking lot/set of spaces. Space A has been designated as available from 1:00 pm-5:00 pm and space B has been designated as available from 2:00 pm-8:00 pm. When parking management system 100 receives a request from visitor A to park in the specified lot from 1:00 pm-3:00 pm and a request from visitor B to park in the lot from 4:00 pm-5:00 pm, the parking management application can assign space A to both visitor A and visitor B, thus leaving space B vacant for other visitors and optimizing the parking arrangement (without optimization, space B could have just as easily have been assigned to visitor B). Additionally, the parking management application can further optimize the parking arrangement based on the additional information/preferences received from the visitor. By way of example, the visitor can specify that he/she prefers (or requires) to park in a covered parking lot. By way of further example, the visitor can specify that he/she prefers to park in the least expensive available space, or that he/she does not wish to park in a space the cost for which is above a certain threshold (as defined by the visitor or generated by the parking management application, such as the average parking fee in the specific area during the requested time/date).

At step 260, having optimized the parking arrangement, the parking management application assigns a parking destination to the visitor based on the optimal parking arrangement. Additionally, as referenced above, under certain circumstances the parking management application can assign parking destinations to several visitors as a result of the optimal parking arrangement.

It should be noted that in one arrangement, order to ensure an optimized parking arrangement, the assignment of the parking destination preferably occurs within a specified time range of the start of the visitor's request (for example, 1 hour prior to the time when the visitor has requested a parking space for). By assigning the parking destination(s) in a relatively close time proximity to the start time of the visitor's parking request, it is expected that parking management system 100 (and specifically database 180) will have accumulated the greatest amount of relevant data (primarily various parking requests from potential visitors and various user inputs from various owners), based on which the parking management application can fully optimize the parking arrangement. Thus, while a visitor may submit a parking request far in advance of the actual date/time of the request, the assignment of a particular parking destination to the visitor will occur later, closer to the time of the request. Alternatively, in another arrangement, the parking management application can assign a parking destination to a visitor substantially immediately after receiving the visitor's parking request. Such an arrangement ensures the visitor instant confirmation of a parking assignment. In order to account for the potential loss of optimization attendant with the immediate assignment of a parking space, in certain arrangements parking management system 100 can implement additional charges in the payment scheme, as will be described in detail below.

Then, at step 270, the parking management application routes or otherwise directs the visitor to the assigned parking space. In one arrangement, the parking management location calculates a set of driving directions (such as turn-by-turn directions) and/or a route map based on the visitor's current location (obtained and/or received from the GPS receiver of mobile communication device 160n, and/or from any other such location determining device) and the location of the assigned parking space. This set of directions/map can further include specific instructions and/or directions which are unique to a particular parking lot. For example, in the case of a large parking lot or structure which has multiple entrances, the parking management application, based on the visitor's current location and the exact location of the assigned space within the lot, can direct the visitor to the best entrance to use based on the various respective locations and other related factors (e.g., congestion in certain areas of the parking lot). These directions, maps, etc. can then be transmitted and/or otherwise conveyed to the appropriate visitor through a network connection. Additionally, in certain arrangements the parking management application can provide additional information and/or instructions that pertain to the specifics of the assigned parking space (e.g., that the visitor must back-in his/her vehicle). All of the referenced information (directions, route map, instructions, etc.) can be viewed by the visitor in an application/app executing at mobile communication device 160n. In another arrangement, the information can be delivered to the visitor through another electronic communication medium such as email and/or SMS message.

At step 280, the visitor (through an application/app executing on mobile communication device 160n) can provide, and the parking management application can receive, an acceptance of the assigned parking space. In certain arrangements, the parking management application can be configured to maintain the assignment of a given parking space only once a confirmation from the visitor is received. In other arrangements, no confirmation is necessary in order to maintain the assignment of a parking space, however the visitor, through an application/app executing on mobile communication device 160n, can subsequently cancel the assignment if the visitor's needs change.

At step 290, the parking management application reconciles a payment scheme. That is, a payment scheme is preferably implemented in conjunction with the various operations of the parking management application in order to incentivize users to utilize parking management system 100. In one arrangement, the parking management application can track the amount of time, frequency, and various other variables associated with the owner of a given parking space designating that space as available. Similarly, the parking management application can track the amount of time, frequency, and various other variables associated with the visitor's utilization of various parking spaces managed by the system 100. It is preferable that the payment scheme be configured such that owners who provide a greater amount of availability of their parking spaces to the system 100 receive greater priority with respect to the assignment of parking spaces by the system for their individual needs when each of them seeks spaces as a visitor. In order to coordinate such a scheme, user accounts are also preferably implemented in parking management system 100 which maintains information relating to users of the system in both an owner and a visitor capacity. For example, in one arrangement the parking management application can maintain a framework of credits, in which an owner providing availability of a parking space results in the accrual of a certain number of credits per time period (e.g., hour, day, etc.), and/or where the usage of a parking space as a visitor results in a deduction of a certain number of credits per time period (e.g., hour, day, etc.). The parking management application can be further configured to account for increases and/or decreases in the supply and demand of parking spaces. Thus, in certain arrangements, the parking management application can provide an owner with more credits during a time of high parking demand (and/or low parking availability), and can similarly deduct more credits from a visitor wishing to park at such a time. In an alternate arrangement, actual cash (such as credit card charges) can be used to credit/deduct from the respective user accounts of the owner and visitor. In yet another arrangement, cash can be used only when the visitor has exhausted his/her accumulated credits.

At step 295, the parking management application can predict future parking space availability. Based on one or more analyses of the data collected throughout the operation of parking management system 100, and specifically data stored in database 180, the parking management application can execute an algorithm in support of a prediction of when a particular parking space may become vacant, and can further prompt the owner accordingly (as to whether the owner wishes to make the space available during that time). By way of example, the parking management application can deduce via data analysis that a particular owner often vacates his/her parking space on Sunday morning, and (through an application/app executing at mobile communication device 106a) can prompt the user in the future to make the space available at the designated time.

Various other features and advantages are present in the parking management system 100. By way of example, being that the payment management application reconciles a payment scheme, as described in detail above, there is little need for visitors to utilize parking tickets to track the parking time, as is currently done in many parking lots/garages. Accordingly, in one arrangement the parking management system 100 can be implemented without any such parking tickets/records. Furthermore, the parking management system 100 can direct a visitor directly to a particular parking space (as described in detail above) without the need to have the user spend additional time searching for a vacant space within the lot.

It should be noted that while the term visitor has been primarily used to refer to a potential visitor to a parking space, in certain arrangements one user may reserve a vacant parking space for another driver, such as a guest who will be visiting them or a repairman. In such a scenario the parking management application can preferably request the license plate number or any other such indentifying information that corresponds to the guest's vehicle.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A system for managing shared usage of a set of parking spaces, each space having a respective owner and being selectively allocated to a visitor, the system comprising:
a processor;
a control circuit operatively connected to the processor;
a memory operatively connected to the control circuit and accessible by the processor;
a communication interface operatively connected to the control circuit; and
one or more software modules encoded in the memory that execute a parking management application in the processor;
wherein the parking management application, when executed by the processor, configures the control circuit to:
receive a user input from an owner through the communication interface, the user input corresponding to a parking space and comprising identification information and availability information relating to the parking space;
receive a user location from the owner through the communication interface, the user location comprising one or more geographical coordinates;
receive a request from a visitor through the communication interface to park among the set of parking spaces;
process the request together with the user input and user location to determine an optimal parking arrangement;
assign a parking destination to the visitor using the determined optimal parking arrangement; and
transmit the assigned parking destination to the visitor.

2. The system of claim 1, wherein the identification information comprises location information of a certain parking space from the set of parking spaces.

3. The system of claim 1, wherein the availability information comprises a start time after which a certain parking space from the set of parking spaces will be available.

4. The system of claim 1, wherein the availability information comprises an end time until which a certain parking space from the set of parking spaces will be available.

5. The system of claim 1, wherein the parking management application configures the control circuit to prompt the owner to input identification information and availability information.

6. The system of claim 5, wherein the parking management application configures the control circuit to prompt the owner in response to the received user location.

7. The system of claim 1, wherein the parking management application configures the control circuit to route the visitor to the parking destination.

8. The system of claim 1, wherein the user input, user location, and request are received from one or more mobile communication devices.

9. The system of claim 1, wherein the request comprises at least one of: a desired start time and a desired end time.

10. The system of claim 1, further comprising one or more software modules encoded in the memory that execute a payment reconciliation application in the processor.

11. The system of claim 10, wherein the payment reconciliation application, when executed by the processor, configures the control circuit to credit a user for at least one of: an availability and an use of a specific parking space from the set of parking spaces.

12. The system of claim 10, wherein the payment reconciliation application, when executed by the processor, configures the control circuit to debit a user for usage of a specific parking space from the set of parking spaces.

13. The system of claim 10, wherein the payment reconciliation application, when executed by the processor, configures the control circuit to provide priority availability to active users in proportion to an activity level.

14. The system of claim 1, wherein the communication interface comprises a network interface.

15. The system of claim 1, wherein the parking management application configures the control circuit to estimate the availability information based on the user location.

16. The system of claim 1, further comprising one or more software modules encoded in the memory that execute a parking space availability inventory application in the processor

17. The system of claim 16, wherein the parking space availability inventory application, when executed by the processor, configures the control circuit to create and maintain an inventory of available parking spaces.

18. The system of claim 17, wherein the inventory of available parking spaces includes the availability information relating to each of the parking spaces.

19. The system of claim 17, wherein the parking management application configures the control circuit to process the request with reference to the inventory of available parking spaces.

20. The system of claim 1, wherein the parking management application configures the control circuit to receive an acceptance of the assigned parking destination from the visitor.

21. A system for managing shared usage of a set of parking spaces, each space having a respective owner and being selectively allocated to a visitor, the system comprising:
a processor;
a control circuit operatively connected to the processor;
a memory operatively connected to the control circuit and accessible by the processor;
a communication interface operatively connected to the control circuit; and
one or more software modules encoded in the memory that execute a parking management application in the processor;
wherein the parking management application, when executed by the processor, configures the control circuit to:
receive a user input from an owner through the communication interface, the user input corresponding to a parking space and comprising identification information and availability information relating to the parking space, wherein the parking space has a first location;
receive a user location from the owner through the communication interface, the user location comprising one or more geographical coordinates;
receive a request from a visitor through the communication interface to park among the set of parking spaces;
process the request in view of the user input and user location to determine an optimal parking arrangement;
compare the user location with the first location and finally determine the optimal parking spot in view of that further comparison;
assign a parking destination to the visitor using the determined optimal parking arrangement; and
transmit the assigned parking destination to the visitor substantially just after the request was received.

22. The system of claim 21, wherein when the user location and the first location are within a prescribed distance then automatically changing the availability information in a database.

23. A computer-implemented method for managing shared usage of a set of parking spaces at a computing device, each space having a respective owner and being selectively allocated to a visitor, wherein the computing device has a processor, a memory accessible by the processor, and a communication interface operatively connected to the processor, the method comprising:
receiving a user input from an owner through the communication interface, the user input corresponding to a parking space and comprising identification information and availability information relating to the parking space;
receiving a user location from the owner through the communication interface, the user location comprising one or more geographical coordinates;
receiving a request from a visitor through the communication interface to park among the set of parking spaces;
processing the request together with the user input and user location to determine an optimal parking arrangement using the processor of the computing device;
assigning in the memory of the computing device a parking destination to the visitor using the determined optimal parking arrangement; and
transmitting the assigned parking destination to the visitor.
